(19) United States
(12) Patent Application Publication
(10) Pub. No.: US 2005/0018723 A1
(43) Pub. Date: Jan. 27, 2005

(54) Method of stabilizing laser beam, and laser beam generation system

(76) Inventors: Masayuki Morita, Saitama (JP); Kazuya Hayashibe, Kanagawa (JP); Yoshiyuki Akiyama, Kanagawa (JP); Hisashi Masuda, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/834,199

(22) Filed: Apr. 29, 2004

(30) Foreign Application Priority Data
May 14, 2003 (JP) P2003-136381

(51) Int. Cl. H01S 3/13

(52) U.S. Cl. 372/29.02

(57) ABSTRACT

A laser beam generation system comprises a solid state laser oscillator excited by an excitation beam, and a Q switch for pulsating laser oscillation by use of a saturable absorber, wherein the optical path length of a laser resonator is variable. The pulse of a laser beam generated from the laser beam generation system is detected, and variation of the optical path length of the laser resonator is controlled based on a characteristic of the detected pulse, to thereby stabilize the laser beam. The laser beam generation system may further comprise resonator length regulation element for varying the optical path length of the laser resonator, and detection element for detecting the pulse laser beam outputted, wherein the optical path length of the laser resonator is regulated by the resonator length regulation element based on a characteristic of the pulse detected by the detection element.

### BACKGROUND OF THE INVENTION

The present invention relates to a method of stabilizing a laser beam and a laser beam generation system, and particularly to a Q switch laser.

A Q switch laser using a saturable absorber is promising as a technology for realizing a Q switch laser by using a continuous oscillation type excitation light source but not using a modulator such as an AOM (Acousto Optical Modulator) or an RF oscillator, and is promising as means for easily realizing a small-type Q switch laser or a high-repetition Q switch laser.

A typical configuration of the Q switch laser using a saturable absorber is shown in FIG. 12 (see Spuhler et al., J. Opt. Soc. Am., Vol. 16, No. 3 (1999), pp.376-388) (this reference will hereinafter be referred to as Non-patent Reference 1).

In this exemplary configuration, a passive Q switch laser is excited by a semiconductor laser.

The Q switch laser 100 shown in FIG. 12 includes a laser medium 101 using Nd:YVO₄, an SBR (Saturable Bragg Reflector) 102 consisting of a reflector and a quantum well based on GaAs as a Q switch, a copper heat sink 103 for heat dissipation, and an output coupler 104 laminated onto the laser medium 101. The above-mentioned saturable absorber is used for the SBR 102.

In the Q switch laser 100, the resonator length RL is equal to the spacing between the interface between the laser medium 101 and the SBR 102 and the interface between the laser medium 101 and the output coupler 104. The resonator length RL may be 200 μm, for example.

An excitation laser beam L1 with a wavelength of 808 nm is inputted from an excitation light source, in this case, a semiconductor laser, whereby a pulse laser beam L2 with a wavelength of 1064 nm is outputted from the Q switch laser 100. In the figure, symbol 105 denotes a dichroic beam splitter, which is so configured as to transmit the excitation laser beam L1 and to reflect the pulse laser beam L2 which is outputted.

Incidentally, in place of the output coupler 104 provided separately from the laser medium 101, a coupler (reflector) may be provided directly on the laser medium 101 by coating.

However, the Q switch laser using a saturable absorber has the drawback that the repetition frequency would be varied to an undesired value due to a change in characteristics peculiar to the saturable absorber (for example, a change in saturable absorption quantity), a change in characteristics of the laser resonator (for example, a change in gain or loss), or the like. In addition, such a variation may be attended by a variation in pulse peak output power and may cause a variation in average oscillation power.

The variation in pulse repetition frequency, the variation in pulse peak output, and the variation in average power have been obstacles in application of the Q switch laser.

Besides, in a laser beam generation system in which the Q switch laser using a saturable absorber is used as a master laser (light source) and a laser beam emitted from the master laser is amplified or is amplified and then subjected to wavelength conversion, a variation in average power or pulse peak power is attended by a variation in amplification characteristics or wavelength conversion efficiency in the subsequent process, resulting in that the variation in final output would be increased further.

For the purpose of confirming the principle of operation, the configuration shown in FIG. 12 has no problem. For practical use, however, the configuration has two problems: one relates to the formation of a stable laser resonator, and the other to the selection of the operating point.

In the Q switch laser such as the Q switch laser 100 shown in FIG. 12, the formation of a thermal lens due to a temperature rise caused by the excitation beam and the perpendicularity between the optical path in the resonator and the mirrors at both ends thereof (in FIG. 12, the SBR 102 and the output coupler 104) have relation with the stability condition of the resonator.

Of these factors, the formation of a thermal lens can be controlled by the formation of an excitation beam spot, and, in ordinary cases, it causes no trouble in designing.

On the other hand, if the optical path in the resonator is not perpendicular to the mirrors at both ends, the resonator loss would increase, to cause such problems as a lowering in output, defective pulse operations, and generation of transverse mode, resulting in that a stable resonator cannot be formed.

In order to form a stable resonator, therefore, the optical component parts of the resonator must have an extremely high parallelism, which increases the production and assembly costs.

The problem relating to the selection of the operating point is that when the optical component parts of the resonator are fixed, the operating point cannot be selected, and, on the other hand, if the optical component parts are not fixed, the operating point would not be constant.

The Q switch laser including a saturable absorber, if not oscillated in longitudinal single mode, would show such an oscillation that a plurality of pulses differing in pulse period or timing are superposed, which is unfavorable for the normal operation expected to generate a pulse train with a fixed timing.

For oscillation in longitudinal single mode, generally, a technique of reducing the resonator length to thereby increase the FSR (Free Spectral Range) relative to the gain width is often used for such a laser. In the case of the longitudinal single-mode oscillation, the effective gain varies with the wavelength (frequency) difference between the gain center and the oscillation longitudinal mode.

In this type of laser using a passive Q switch, a slight shift of the operating point can be achieved by minutely varying the gain or the refractive index through a variation in temperature. However, it is not possible to match the oscillation frequency to the gain peak, as originally desired. The repetition frequency of the pulse is substantially determined by the resonator length at the time of fixation thereof, and the range of subsequent regulation is limited.

Particularly, in the case where the gain peak is located substantially at the midpoint between two adjacent longitudinal modes, the two longitudinal modes concur, leading to instability of the pulse, and, for a shifting from such an operating point to the desired operating point, resonator length regulation means for regulation by not less than about ¼ times the wavelength is needed.

In conclusion, the conventional configuration as shown in FIG. 12 can cope with the problems as to the accuracy of component parts or in assembly and the steadiness after adhesion, but cannot permit modification of the resonator length. Therefore, the conventional configuration has the problem that it is difficult to set the initial operating point at a favorable position.

In view of this, in order that the resonator length can be varied with the temperature of the resonator, it may be contemplated to adopt the configuration of a passive Q switch laser shown in FIG. 13.

In this Q switch laser 110, a laser medium 113 composed, for example, Nd:YVO₄ or the like and an SBR 114 are attached respectively to support members 112 formed of quartz, sapphire or the like and are disposed opposite to each other. The two support members 112 are vertically fixed to a substrate 111 by, for example, adhesion.

In the case of this configuration of the Q switch laser 110, with the substrate 111 formed of a material having a comparatively good thermal conductivity and a high coefficient of thermal expansion, such as aluminum, it is possible to easily expand and contract the resonator length within the width of about the wavelength by varying the temperature of the substrate 111.

The Q switch laser 110 is a laser having a resonator temperature dependence as shown, for example, in FIG. 14, though depending on the expansion characteristics (coefficient of thermal expansion) of the substrate 111 and on the distance between the two support members 112. In FIG. 14, the axis of ordinates represents average power Pav and repetition frequency Rep-rate, and the axis of abscissas represents the temperature T of the substrate 111. The average power Pav and the repetition frequency Rep-rate are substantially proportional to each other.

By varying the temperature T of the substrate 111, it is possible to vary the resonator length and thereby to change the operating point from a multi-mode oscillation range into a single-mode oscillation range.

Where this configuration of the Q switch laser 110 is adopted, however, maximal values of repetition frequency may not necessarily be constant but may vary, depending on the temperature characteristics of gain of the gain medium and on the temperature characteristics of the semiconductor Q switch. As shown in FIG. 14, generally, the maximal value is lower on the high-temperature side.

In addition, where this configuration of the Q switch laser 110 is adopted, changes with time are generated, whereby long-term stability is lost. For example, slight deformation such as expansion and contraction of the adhesive may be generated, with the contact point between the substrate 111 and the support member 112 as a fulcrum, whereby the resonator length is changed by no less than about a fraction of the wavelength.

As a result, even at the same resonator temperature, the operating point may be changed toward the worse side from the designed operating point.

This means that the curve shown in the characteristic diagram in FIG. 14 is moved to the right side (from the solid-line position to the broken-line position) as shown in FIG. 15A or moved to the left side as shown in FIG. 15B. Such a change causes variations in the temperatures giving maximal values of average power and repetition frequency and in the maximal values (peak heights), resulting in that the original characteristics cannot be recovered by simply recovering the original temperature.

Even if the temperature of the substrate 111 is re-set for compensating for the variations, it would be necessary to provide a temperature change of about 10° C. or more, in order to give the thermal expansion required for the compensation.

Next, consideration will be made of the influences generated in the case where the resonator length in the Q switch laser 100 configured as shown in FIG. 12 is made different from a set point at the time of initial assemblage and in the case where changes with time are generated in the Q switch laser 110 configured as shown in FIG. 13.

First, where such a laser is used singly, the initial values or elapsed values of average power and repetition frequency would be shifted from the desired values.

In the case of a system utilizing repetition frequency, the variation in the repetition frequency constitutes a problem.

On the other hand, in the case where pulse peak power is utilized, the variation in the peak power has adverse effects on the micro-process and the like.

Besides, in the case of performing wavelength conversion by inputting an output into a nonlinear optical device, also, the conversion efficiency is dependent on peak power, so that the variation in the peak power causes large variations in the output obtained through the wavelength conversion.

Further, in the case of using such a laser as a master laser for an amplifier such as a fiber laser, a semiconductor laser, and a solid state laser to thereby construct a so-called MOPA (Master Oscillator Power Amplifier), there may occur the problems that the variation in repetition frequency causes variations in energy amplification value of each pulse, that the variation in peak power damages the amplifier or optical systems used in the subsequent stages, and that nonlinear optical effects such as inductive Raman scattering and self phase modulation cause a lowering in efficiency in the form an energy shift to an unexpected wavelength or deformation of the pulse shape.

In addition, in the case of a system in which a pulse amplified by the MOPA is subjected further to wavelength conversion, the wavelength conversion efficiency may be maximized by conducting the wavelength conversion at a peak power at the boundary between the generation and the non-generation of damages or Raman scattering.

In this case, therefore, if the damages or Raman scattering should be generated due to a variation in repetition frequency or pulse duty ratio (the ratio of average power to pulse peak power), the wavelength conversion efficiency would be lowered.

Here, in a system in which the Q switch laser using a saturable absorber is used as a master laser for a fiber laser to construct the above-mentioned MOPA and a pulse amplified by the MOPA is subjected further to wavelength conversion, the relationship between an output from an SHG (Second Harmonic Generation) device for performing the wavelength conversion and the condition of pulse of the power outputted from the Q switch laser is shown in FIG. 16.

In FIG. 16, the axis of abscissas represents the ratio of pulse peak power to average power, and the axis of ordinates represents the SHG output from the SHG device.

In the range where the ratio is low, the SHG output increases as the ratio increases, but, in the range where the ratio is high, the SHG output decreases as the ratio increases, due to the generation of Raman scattering. Namely, the SHG output reaches the maximum peak when the ratio of pulse peak power to average power is at a certain value.

In view of this, the ratio of pulse peak power to average power is so set that the SHG output is located in the vicinity of the maximum peak. If the thus set value should be varied due to any of the above-mentioned various factors, the SHG output is shifted from the maximum peak, resulting in a lowering in the output.

Incidentally, FIG. 16 is a representative of the cases where the average power is at a certain value. The maximum peak value and the value of the ratio giving the maximum peak vary depending on the magnitude of the average power, and there is the tendency that the maximum peak value is higher as the average power is higher.

### SUMMARY OF THE INVENTION

The present invention has been made in order to solve the above-mentioned problems. Accordingly, it is an object of the present invention to provide a method of stabilizing a laser beam and a laser beam generation system with which it is possible to vary the resonator length, to compensate for variations in a characteristic of a laser beam, and to obtain long-term stability.

In accordance with one aspect of the present invention, there is provided a method of stabilizing a laser beam generated from a laser beam generation system including a solid state laser oscillator excited by an excitation beam, and a Q switch for pulsating laser oscillation by use of a saturable absorber, wherein the laser beam generation system is so configured that the optical path length of a laser resonator can be varied, a pulse of the generated laser beam is detected, and the variation of the optical path length of the laser resonator is controlled based on a characteristic of the detected pulse.

In accordance with another aspect of the present invention, there is provided a laser beam generation system including a solid state laser oscillator excited by an excitation beam, and a saturable absorber Q switch for pulsating laser oscillation by use of a saturable absorber, wherein the laser beam generation system further includes resonator length regulation means for varying the optical length of a laser resonator, and detection means for detecting a pulse laser beam outputted, and the optical path length of the laser resonator is regulated by the resonator length regulation means based on a characteristic of the pulse detected by the detection means.

According to the method of stabilizing a laser beam of the present invention, the pulse of a laser beam generated is detected, and the variation of the optical path length of a laser resonator is controlled based on a characteristic of the detected pulse, whereby it is possible to correct the optical path length of the laser resonator to a desired optical path length by controlling the variation of the optical path length based on the characteristic of the pulse detected, in response to a variation in the optical path length due to a disturbance.

According to the configuration of the laser beam generation system of the present invention, the laser beam generation system includes resonator length regulation means for varying the optical path length of a laser resonator, and detection means for detecting a pulse laser beam outputted, and the optical path length of the laser resonator is regulated by the resonator length regulating means based on the characteristic of the pulse detected by the detecting means. Therefore, it is possible, even in the case where the optical path length of the laser resonator is varied due to a disturbance, to correct the optical path length to a desired optical path length by regulating the optical path length by the resonator length regulation means based on the characteristic of the pulse detected.

More specifically, according to the present invention, it is possible to compensate for the variations in the characteristics such as pulse repletion frequency and pulse duty ratio due to minute changes in the resonator length and disturbances arising from a semiconductor laser used as an excitation light source and the like, and thereby to maintain constant characteristics.

In addition, according to the present invention, since the pulse duty ratio can be kept constant, it is possible to maintain the output obtained upon wavelength conversion at an optimum output in the case where, for example, an output beam from a Q switch is amplified and then subjected to wavelength conversion.

Furthermore, according to the present invention, since the variation in the characteristic can be compensated, it is possible to maintain the characteristic in a good condition over a long time, and to enhance reliability.

Therefore, a laser beam generation system capable of operating stably over a long time and being high in reliability can be realized.

### BRIEF DESCRIPTION OF THE DRAWINGS

The above and other objects, features and advantages of the present invention will become apparent from the following description and appended claims, taken in conjunction with the accompanying drawings, in which:

FIG. 1 schematically illustrates the configuration of a laser oscillator constituting a laser beam generation system according to one embodiment of the present invention;

FIG. 2 schematically illustrates the configuration of the laser beam generation system according to one embodiment of the present invention;

FIG. 3 is a diagram showing the relationships between a voltage impressed on resonator length regulation means, in the laser beam generation system of FIG. 2, and average power and repetition frequency;

FIG. 4 is a diagram showing one form of functional blocks for maintaining repetition frequency at a maximal peak, in the laser beam generation system of FIG. 2;

FIG. 5 is a diagram showing the variation of Δf/Δu shown in FIG. 4;

FIG. 6 is a diagram showing a form in which functional blocks for correcting the maximal peak of repetition frequency are further added to the functional blocks of FIG. 4;

FIG. 7 is a diagram showing another form of functional blocks for maintaining repetition frequency at a maximal peak, in the laser beam generation system of FIG. 2;

FIG. 8 is a diagram showing a form in which functional blocks for correcting the maximal peak of repetition frequency is further added to the functional blocks of FIG. 7;

FIG. 9 is a diagram showing the case where a circuit for controlling the laser beam generation system of FIG. 2 is configured by use of a microprocessor and a memory;

FIG. 10 is a diagram illustrating a laser beam generation system in which the laser beam generation system of FIG. 2 is used as a master laser;

FIG. 11 schematically illustrates the configuration of a display constructed by use of the laser beam generation system of FIG. 2;

FIG. 12 schematically illustrates the configuration of a Q switch using a saturable absorber;

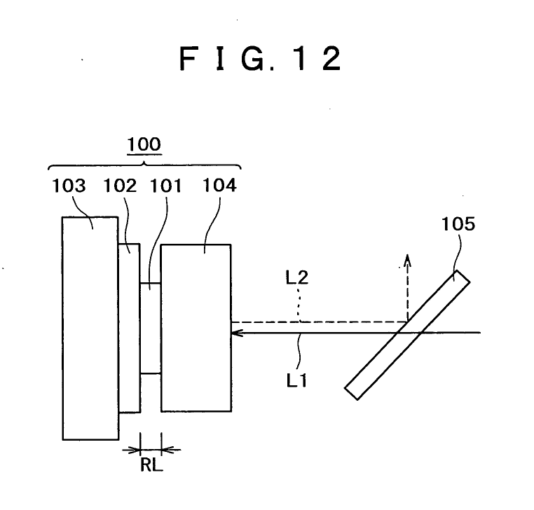

FIG. 13 schematically illustrates the configuration of a Q switch laser in which the resonator length is variable;

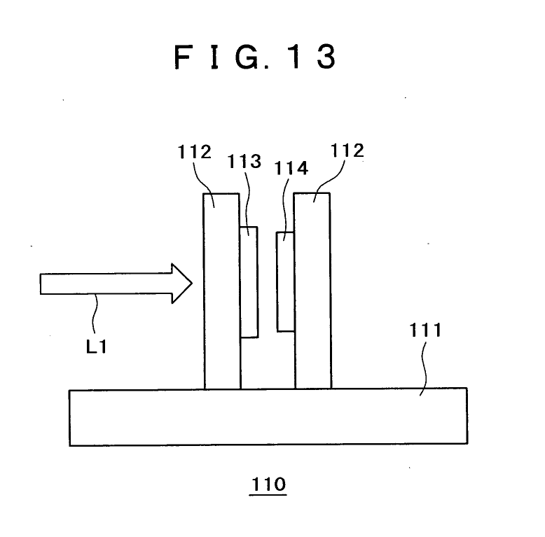

FIG. 14 is a diagram showing the temperature dependency of average power and repetition frequency in the Q switch laser of FIG. 13;

FIGS. 15A and 15B are each a diagram showing the condition where the curve of FIG. 14 is moved to the right side or the left side; and

FIG. 16 is a diagram showing the relationship between the ratio of pulse peak power to average power and SHG output.

### DETAILED DESCRIPTION OF THE PREFERRED EMBODIMENTS

Now, as embodiments of the present invention, one embodiment of the laser beam generation system and the method of stabilizing a laser beam in the laser generation system will be described.

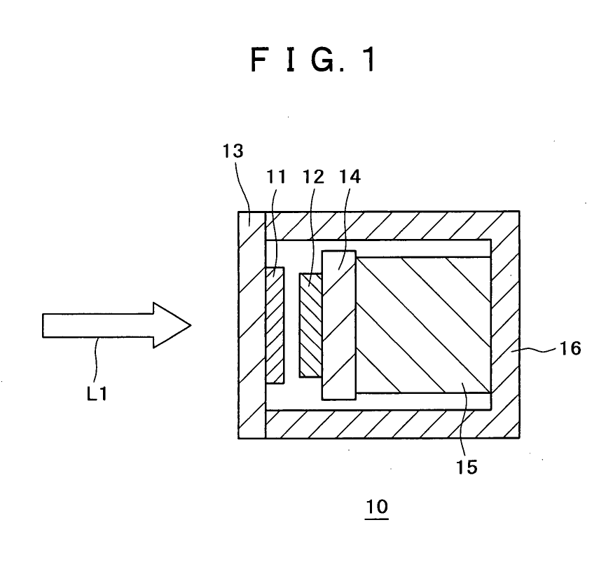

First, FIG. 1 schematically illustrates the configuration of a laser oscillator constituting the laser beam generation system according to this embodiment.

The laser oscillator 10 has a structure in which a laser medium 11 and an SBR (Saturable Bragg Reflector) 12 are disposed opposite to each other and are attached respectively to support members 13 and 14 which are formed of quartz, sapphire or the like.

As the laser medium 11, for example, Nd:YVO₄, Nd:YLF (YliF₄) and the like can be used. The oscillation wavelengths of Nd:YVO₄ are 1064 nm and 1340 nm, while the oscillation wavelength of Nd:YLF is 914 nm.

Other than these, optical crystals or glasses doped with a rare earth element such as Nd, Er, Yb, Sm, and Pr can also be used.

As has been mentioned above, the SBR 12 functions as a Q switch for the laser medium 12. As above-mentioned, the SBR 12 comprises, though not shown, a semiconductor quantum well based on GaAs, for example, and a reflector, and is constituted to comprise a saturable absorber. The SBR 12 may comprise a DBR (Distributed Bragg Reflector), for example.

As the saturable absorber, for example, semiconductor saturable absorbers utilizing the above-mentioned semiconductor quantum well, dielectric solids doped with Cr ion such as Cr:YAG, and the like can be used.

In this embodiment, particularly, resonator length regulation means 15 is provided between the support 14 to which the SBR 12 is attached and an outside casing 16, to configure the laser oscillator 10.

As the resonator length regulation means 15, for example, piezoelectric devices using a piezoelectric material such as PZT (lead zirconate titanate) can be used.

The resonator length regulation means 15 may have one of various configurations, for example, VCM (Voice Coil Motor), MEMS (Micro Electro Mechanical Systems) actuator (for example, a configuration for displacement by electrostatic capacity, as used in GLV (Grating Light Valve)), a configuration for varying the resonator length through variation of temperature, a leaf spring, etc. As the configuration for varying the resonator length through variation of temperature, for example, a heater or a Peltier device may be provided.

With the resonator length regulation means 15 thus provided, it is possible, by operating the resonator length regulation means 15, to vary the spacing between the laser medium 11 and the SBR 12 and thereby to vary the resonator length.

With the resonator length varied in this manner, it is possible to bring the operating point of the laser oscillator 10 to a desired operating point, as will be described in detail later.

Incidentally, while a configuration in which the resonator length is decreased when the resonator length regulation means 15 is extended is adopted in the laser oscillator 10 shown in FIG. 1, there may also be adopted a configuration in which the resonator length is increased when the resonator length regulation means is extended, on the contrary to the above.

Where the resonator length regulation means 15 is composed of a piezoelectric device using PZT or the like, it is possible to extend or contract the resonator length regulation means 15 by impressing a voltage thereon, and thereby to change the resonator length.

The resonator length varies substantially linearly relative to the voltage impressed.

Incidentally, due to the characteristics of the piezoelectric device using PZT or the like, the variation of the resonator length may have a bit of hysteresis. Even if such a hysteresis is present, however, it is possible to obtain a good behavior in the vicinity of the operating point by continuedly correcting a driver signal until a set point is reached by use of a servo control, as will be described later.

Here, the relationships between the voltage (V) impressed on the resonator length regulation means 15 formed of PZT and average power Pav and repetition frequency Rep-rate of the laser beam outputted from the laser oscillator 10 are shown in Fig. F3, in which the impressed voltage is taken on the axis of abscissas, and the average power Pav and repetition frequency Rep-rate of the laser beam are taken on the axis of ordinates. Incidentally, a similar curve appears also in the case where variation in laser output is taken on the axis of ordinates.

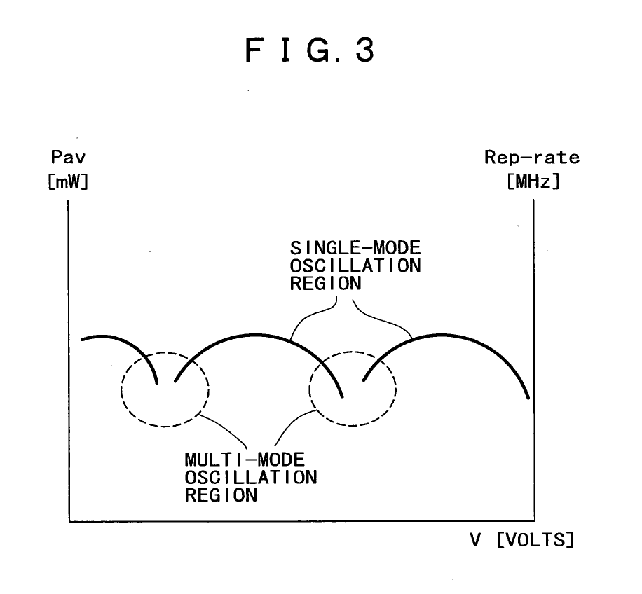

In the vicinity of each peak in FIG. 3, a longitudinal mode is located in the vicinity of a gain center, so that this region is stable and favorable for operation. Between two peaks, there is an area where the two adjacent longitudinal modes are substantially equally spaced from the gain center and where a longitudinal multi-mode appears. In this area, it is highly possible that a plurality of different-phase pulses or a plurality of different-frequency pulses are present in mixture.

Therefore, unless a special reason is present, an initial setting matched to a maximal value of repetition frequency is adopted in many cases. Such a setting widens the margin allowed for disturbances such as minute expansion of the resonator.

In an exceptional case, a value on a slope portion other than the maximal values (peaks) may unavoidably be used as an operating point and a servo control may be performed with this value as a set point, owing to a narrow stable-operation range or the like reason. Normally, however, a peak is selected as an operating point, and the operating point is maintained at the peak.

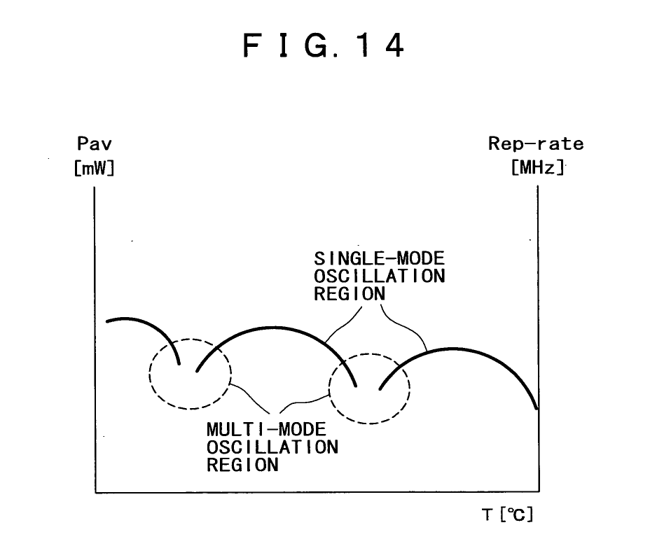

As is seen from a comparison between FIG. 3 and FIG. 14, the maximal values of average power Pav and repetition frequency are constant in FIG. 3. Namely, the maximal values of average power Pav and repetition frequency Rep-rate are unchanged even upon variation in the resonator length by impressing a voltage on the resonator length regulation point 15.

In a photodetector, for example, a photodiode, the laser beam outputted from the laser oscillator 10 is detected, specifically, the pulse repetition frequency or the pulse duty ratio (the ratio of average power to pulse peak power) of the laser beam is detected, and the result of detection is fed back to the resonator length regulation means 15, whereby the operating point of the laser oscillator 10 can be maintained at the maximal peak.

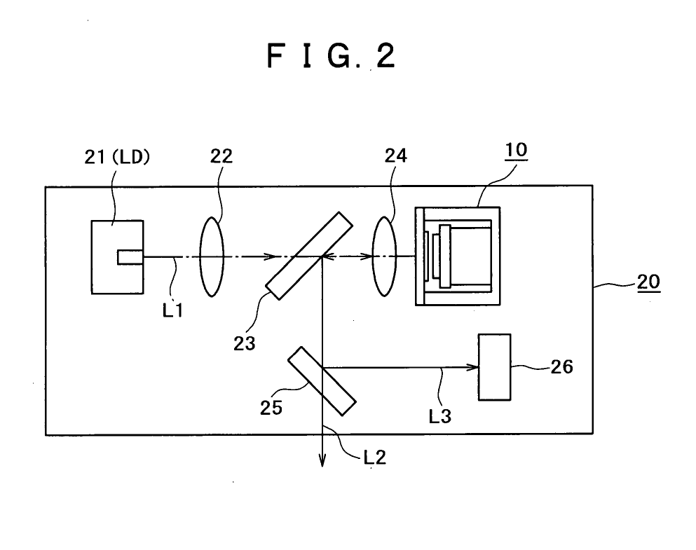

For this purpose, in the laser beam generation system according to this embodiment, as shown in FIG. 2, the laser beam generation system 20 is configured by providing a servo system.

The laser beam generation system 20 comprises an excitation optical system which is comprised of a laser oscillator 10 configured as shown in FIG. 1, an excitation light source 21 composed of a semiconductor laser LD, a lens 22, an output take-out mirror 23, and a lens 24 and in which a laser medium 11 is excited; and a photodetector 26 for detecting the laser beam emitted from the laser oscillator 10. The photodetector 26 is composed of a light-receiving device, for example, a photodiode.

In addition, the inside of the laser beam generation system 20 is wholly maintained in a thermostatic (fixed-temperature) condition.

The laser beam generation system 20 operates as follows.

A laser beam L1 from the excitation light source 21 composed of the semiconductor laser LD is transmitted through the lens 22, the output take-out mirror 23, and the lens 24, to be incident on the laser oscillator 10.

Besides, the beam emitted from the laser oscillator 10 passes through the lens 24, is reflected by the output take-out mirror 23 to be taken out to the lower side in the figure, and, further, a portion thereof is reflected by a mirror 25 to be taken out as a detection beam L3, which is detected by the photodetector 26. The residual portion of the emitted beam is transmitted through the mirror 25, to be taken out as an output beam L2 to the exterior of the laser beam generation system 20.

With the laser beam generation system 20 configured as above, the pulse repetition frequency and the pulse duty ratio of the laser beam emitted from the laser oscillator 10 can be detected from the detection beam L3 detected at the photodetector 26. The result of the detection is fed back to the resonator length regulation means 15 in the laser oscillator 10, whereby the operating point of the laser oscillator 10 can be maintained at a maximal peak.

Here, it is presumed that, in the range of the operating voltage of the resonator length regulation means 15 composed of PZT and in the range of variation of the operating point of the excitation light source 21, the variations in the pulse width of the output beam L2 are substantially negligibly small.

As described in Non-patent Reference 1 mentioned above, the pulse width Δt of the output beam L2, in normal case, is given by the following formula (1), where T_{G} is the cycle time of the resonator, and q₀ is the saturable absorption quantity:

$$Δ t = \frac{3.52 {T}_{G}}{{q}_{o}} \qquad ( 1 )$$

Let the cycle optical path length of the resonator be L, and let the velocity of light in vacuum be c, then T_{G}=c/L. In consideration of the fact that a typical value of L is several hundreds of micrometers, it suffices that the variation amount necessary for the resonator length is on the order of the wavelength (several hundreds of nanometers), i.e., about one thousandth of L. Here, L can be deemed as substantially constant, and T_{G} can be deemed as constant. As a result, the pulse width Δt can be deemed as constant.

Therefore, in such a range that the pulse width A t is thus substantially constant, by keeping constant the repetition frequency, namely, by keeping constant the cycle time, it is possible to simultaneously keep constant also the pulse duty ratio (the ratio between pulse peak power and average power, which coincides substantially with the ratio between pulse cycle period and pulse width Δt).

Here, specifically, consideration will be made of the case where the laser beam generation system 20 according to this embodiment is constructed, for example, by using Nd:YVO₄ as the laser medium 11 in the laser oscillator 10.

The laser beam oscillated from Nd:YVO₄ has the three typical wavelengths of about 1342 nm, about 1064 nm, and about 914 nm.

While Nd:YVO₄ has numbers of oscillation wavelengths and absorption wavelength bands, the absorption band in the vicinity of 808 nm corresponding to the Nd³⁺ ion is famous, and semiconductor lasers matched to this wavelength band are easily available. Therefore, it is recommendable to use a semiconductor laser LD having an output at this wavelength as the excitation light source 21.

As Nd:YVO₄ for use as the laser medium 11, Nd:YVO₄ having an Nd ion concentration of about 0.5 to 3% is used. Generally, a b-cut substrate is used for Nd:YVO₄, and polarized light parallel to the c-axis of YVO₄ is ordinarily used for excitation polarized light in view of the high absorption coefficient.

In addition, the laser medium 11 is considered to oscillate with the c-polarized light which gives a high gain at 1064 nm.

As for the thickness of the Nd:YVO₄ substrate, an increase in the thickness increases the absorption quantity of the excitation beam, making it possible to enhance the output and the repetition frequency. On the other hand, it is attended by an increase in the resonator length, leading to easier occurrence of longitudinal multi-mode oscillation. Thus, there is a trade-off.

In view of this, for contriving both the enhancement of output and repetition frequency and the prevention of multi-mode oscillation, the thickness of the Nd:YVO₄ is set in the range of about 50 to 500 μm. For example, the thickness may be set at 150 μm.

Of the excitation beam emitted from the excitation light source 21, about 10 to 80% is absorbed in the Nd:YVO₄ substrate of the laser medium 11, and, of the absorbed beam portion, the phonon transition not used for oscillation and the space portions not contributing to oscillation and the like are converted into heat, so that a thermal lens is formed which is centered in the vicinity of the center of the excitation portion.

The thermal lens thus formed and regulation of resonator component parts are used to fabricate a stable resonator, which oscillates in a resonator mode with a radius of about 15 to 30 μm at the wavelength of 1064 nm.

The mirrors of the resonator are composed of the output coupler (transmittance: 0.5 to 70%) formed on the surface of the laser medium (Nd:YVO₄), and the semiconductor distributed Bragg reflector (DBR) formed in the SBR 12, and, therefore, these mirrors are regulated to thereby regulate the transverse mode. In normal cases, it is desirable to regulate the mirrors so as to achieve a transverse single mode.

In addition, from the viewpoint of stability of pulse repetition, it is desirable for the longitudinal mode to be a single mode. As described in Non-patent Reference 1 mentioned above, it is a common practice to reduce the thickness of the laser medium, thereby to reduce the resonator length, and to ensure that the longitudinal mode becomes a single mode.

Meanwhile, the operating point set initially is considered to be varied due to the above-mentioned changes with time, in the absence of negative feedback. For example, when the resonator optical path length is slightly changed by such causes as the expansion or contraction of the adhesive due to humidity and temperature variations and changes with time (chemical reactions, release of gas), the attendant mechanical positional variations, variations in output due to deterioration with time of the semiconductor laser or optical devices, the attendant variations in the temperature of the laser medium, etc., the gain center of the laser medium and the position of the laser longitudinal mode would be set off from each other and the output and repetition frequency would be changed due to net gain variations, unless the slight change is compensated for.

Taking the variation in the thickness of the adhesive as an example, a 1% deformation due to contraction of the adhesive layer about 10 μm in thickness results in a 100 nm change in the resonator length.

The spacing between the adjacent peaks in FIG. 3 corresponds to a difference of λ/2 in the resonator length (one reciprocation corresponds to one wavelength), and λA/2 is equivalent to 532 nm in the case of an oscillation wavelength of 1064 nm. In this case, for example, if the operating point is shifted from the peak by 266 nm, the operating point having been at the peak would be shifted into the unstable region where multi-mode oscillation occurs.

Therefore, a change of 100 nm in the resonator length is estimated to move the operating point to the vicinity of a roughly middle point between the peak and the unstable region, thereby causing large variations in output and repetition frequency. Actually, this estimation has been confirmed experimentally.

Such a minute change in the resonator length may occur in a short time, and it cannot be considered that such a change will not occur at all over a long time after the completion of the laser. Accordingly, it is necessary to perform some sort of automatic compensation or correction.

On the other hand, a changed repetition frequency can be corrected, for example, by adopting the following method.

First, in the first stage, the repetition frequency is maintained at the position of a maximal value in relation to variation of the resonator length.

For this purpose, it is necessary to adopt a method in which, for example, a dither signal is added to the voltage impressed on the resonator length regulation means 15 to produce a primary differential signal, and negative feedback is applied so as to reduce the primary differential signal to 0, thereby locking the operating point at the position of a maximal value of repetition frequency.

In the range where disturbances are slight, the pulse width can be deemed as substantially constant, so that the repetition frequency is then on maintained at a constant value, unless the maximal value changes. The frequency and amplitude of the dither signal are selected at such values as not to affect the output beam. The values vary depending on the operation of the actuator such as PZT constituting the resonator length regulation means 15. For example, where PZT such that the voltage necessary for an optical path change of a half wavelength (in the above-mentioned case, 532 nm) is 100 V is used, it is desirable to use a frequency of 100 Hz and an amplitude of not more than 1 V, for example.

When the variation in repetition frequency is divided by the voltage changed by the dither signal, a quantity corresponding to the primary differential signal is derived, which becomes an error signal relating to the voltage change.

By always causing a minute movement in such a direction as to reduce the variation of the error signal to 0, it is possible to lock the operating point at the maximal value of repetition frequency. The maximal value can be deemed as always constant under predetermined conditions, and, therefore, this servo control makes it possible to maintain the repetition frequency, and hence the pulse duty ratio, within a predetermined range to such an extent that no problem is generated on a practical-use basis.

Besides, even if the resonator length is changed on the order of several times the wavelength, the maximal value of the repetition frequency can still be deemed as substantially constant; therefore, the repetition frequency can be kept constant by the servo control, provided that the change is within the movable range of the actuator such as PZT.

Incidentally, in the case of using a VCM (Voice Coil Motor) as the resonator length regulation means 15, a current is applied in place of impressing a voltage. In this case, it suffices to vary the current applied to the VCM by a dither signal, to divide the variation of repetition frequency by the variation of the current, thereby deriving a quantity corresponding to a primary differential coefficient, and to use the quantity as an error signal relating to the current variation.

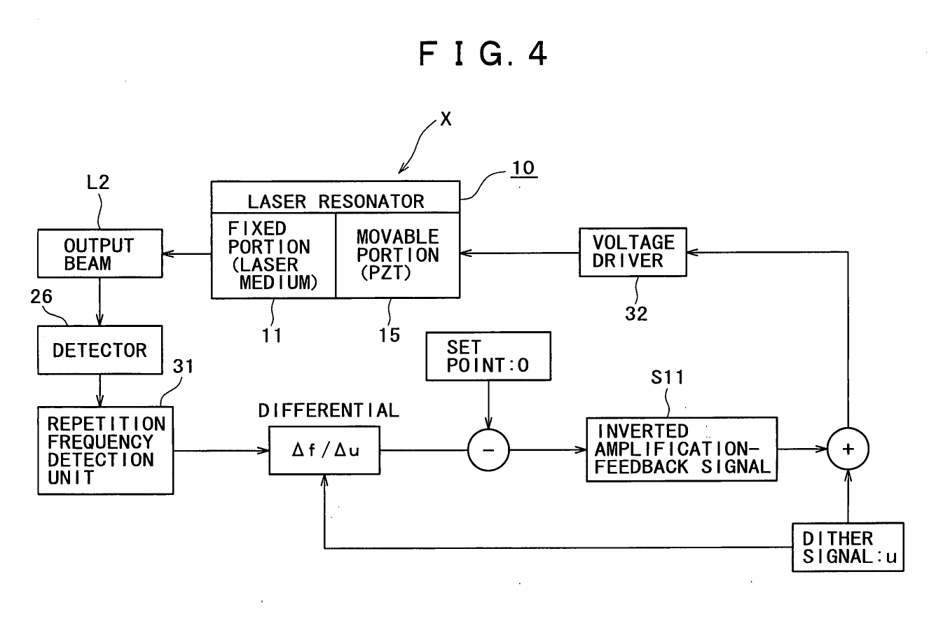

Here, FIG. 4 shows one form of each functional block so configured as to maintain the repetition frequency at a maximal peak as above-mentioned, for the laser beam generation system 20 according to the embodiment shown in FIG. 2.

In FIG. 4, a repetition frequency detection unit 31 is provided for detecting the repetition frequency from an output beam L2 detected by a detector 26.

Then, a dither signal u is added to a signal which is given to a voltage driver 32 for impressing a voltage on a movable portion of a laser oscillator 10, namely, resonator length regulation means 15 composed of PZT.

The variation Δf of the repetition frequency f is divided by the voltage Δu changed by the dither signal u, to obtain a primary differential signal Δf/Δu, and negative feedback is performed with the primary differential signal as a set point 0. Specifically, the primary differential signal is inverted to obtain an inverted amplification-feedback signal S11, which is added to the dither signal u.

Then, the resonator length is regulated by the resonator length regulation means 15 so that the primary differential signal Δf/Δu is reduced to 0, whereby the repetition frequency changed by a disturbance X exerted on the laser oscillator 10 can be corrected to the maximal value.

Incidentally, in place of providing the repetition frequency detection unit 31 as shown in FIG. 4, a pulse separation detection unit may be provided to thereby detect the pulse separation.

Now, the method of correcting the repetition frequency, in the case where the functional block shown in FIG. 4 is configured, will be described in more detail below.

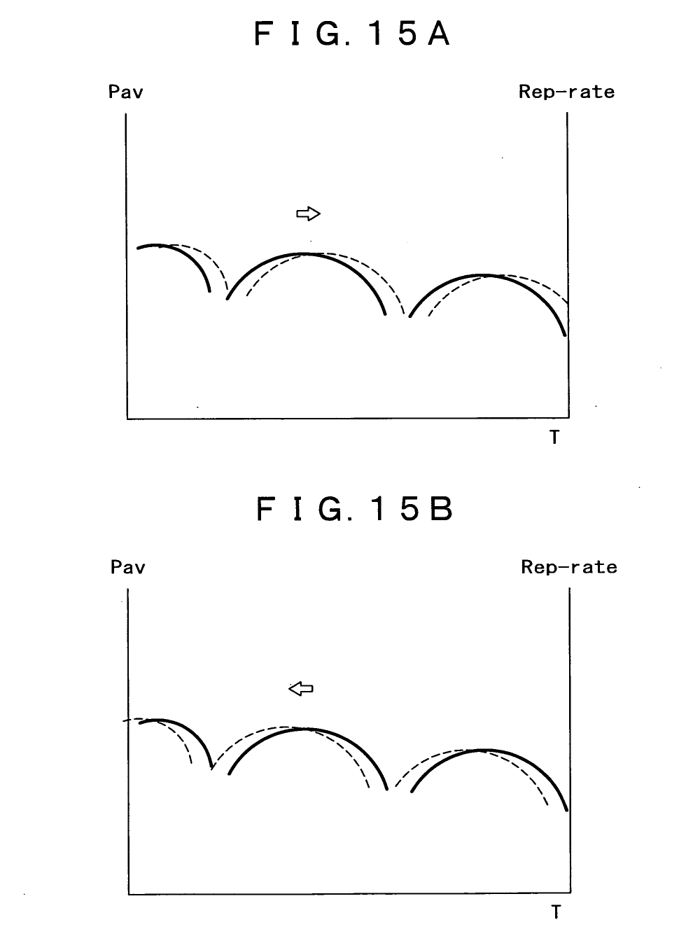

When the disturbance X is exerted on the laser oscillator 10 in the form of a variation in resonator length, the operating condition for the same voltage is changed, with the result that the curve shown in FIG. 3 is shifted to the right side or to the left side. This point is the same as in the case shown in FIGS. 15A and 15B. Examples of the cause of the disturbance X comprise the temperature, humidity and degassing of the adhesive, changes with time, and changes in environmental temperature.

However, the shape of the graph is unchanged, provided that the variation in resonator length is a tiny variation.

Therefore, when the direction of the offset (the shift of the curve) is detected in some form and the operating point of the resonator length regulation means 15 composed of PZT or the like is changed so as to obtain the same condition as the original resonator length, the initially intended condition must surely be restored.

In view of this, in FIG. 3, the correction method to be used in the case where the repetition frequency has been changed by the disturbance X exerted on the resonator as above-mentioned will be described.

From a portion of the output beam L2 caught by the photodetector 26, the repetition frequency is read in the repetition frequency detection unit 31. Where a pulse separation detection unit is provided, the pulse separation is read.

In this case, actually, a small dither signal u is always added to the operating voltage for the resonator length regulation means 15 composed of PZT, whereby the resonator length in the laser oscillator 10 is minutely varied at a specified frequency, and the direction of the voltage variation and the variation Δf of the repetition frequency f are always monitored.

If the operating point is in the vicinity of a maximal point, Δf/Δu has a very small value (which can be deemed as 0), irrespective of the polarity of the variation Δu in the dither signal u.

Upon such a shift that the maximal point is located on the higher-voltage side of the operating point, the operating point is located on the left side of the maximal point, Δf is minus when Δu is minus, and Δf is plus when Δu is plus, so that Δf/Δu takes a plus value.

On the contrary, upon such a shift that the maximal point is located on the lower-voltage side of the operating point, the operating point is located on the right side of the maximal point, Δf is plus when Δu is minus, and Δf is minus when Δu is plus, so that Δf/Δu takes a minus value.

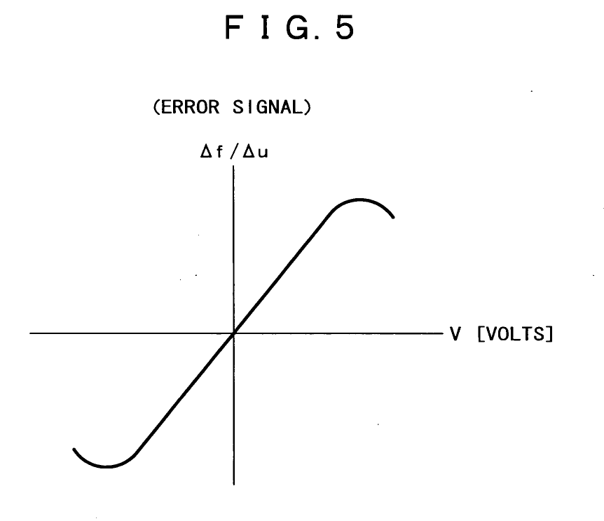

The variation of Δf/Δu is shown in FIG. 5. In FIG. 5, the axis of abscissas represents the difference between the operating point and the maximal point as the difference (V) of the voltage impressed on the resonator length regulation means 15, and the axis of ordinates represents Δf/Δu.

As shown in FIG. 5, the graph is an S-shaped curve, and Δf/Δu=0 when the operating point and the maximal point coincide with each other; thus, it is seen that a so-called error signal is obtained.

Therefore, when negative feedback is successfully applied so that the error signal is reduced to 0, the varied repetition frequency can be corrected and maintained at a fixed value through the so-called servo control.

However, a maximal value of the voltage dependence of repetition frequency varies as a function of the light quantity of the excitation beam absorbed, the temperature of the resonator, and the like. Therefore, it is necessary to maintain these factors at constant values.

On the other hand, in the case where the values of these factors vary, for example, in the case where the absorption by Nd:YVO₄ are varied attendant on variations of the current or temperature of the semiconductor laser due to changes with time or the like, in the case where the operating temperature of Nd:YVO₄ or the SBR is varied attendant on a variation in the resonator temperature, in the case where the quantity of laser beam inputted from the semiconductor laser into the SBR is varied attendant on a change of the position of the SBR, or in the like cases, it is highly possible that the maximal value may be varied.

In such a case, it is impossible to keep constant the pulse duty ratio by only performing the servo control for maintaining the operating point at the maximal point.

Assuming that the pulse repetition frequency (or pulse duty ratio) is maintained at a maximal value, in order to compensate for a variation of the maximal value, it is necessary to vary another parameter.

In view of this, as the second stage, it is necessary to correct the maximal value to the original value. As the means for correction, correction means with the most linear response is preferably used.

Examples of such correction means comprise a change of the current for the semiconductor laser LD in the excitation light source 21.

Other means can also be used but are not so appropriate. For example, when a change of resonator length with temperature is used for the correction, the variation of the resonator length with the temperature change is so small that it is necessary to change the temperature greatly. On the other hand, when a change of the position of the SBR is used for the correction, the variation of the maximal point may show a nonlinear response to the change of the position of the SBR.

The current for the semiconductor laser LD is the easiest to deal with, and is considered to be the best from the viewpoints of linearity, circuit configuration, response properties, and the like. Since a change of the current in the excitation light source 21 is attended by a variation in the wavelength of the excitation light source 21, the response is not necessarily simple; however, it is possible to set a range where a linear response is obtained on a macroscopic basis.

The servo control in this case is not to hold the maximal value. Therefore, by setting a desired repetition frequency and thereafter treating the difference between the set point and the current value as an error signal, a normal servo system can be configured.

In addition, by controlling the current supplied to the driver circuit for the semiconductor laser LD, namely, by controlling the current supplied to the semiconductor laser LD, it is possible to control the oscillation wavelength of the laser oscillator 10. Therefore, it is possible to control the oscillation wavelength of the laser oscillator 10 to an oscillation wavelength giving a maximum of the laser gain which is determined by respective spectral characteristics of the laser medium 11 and the saturable absorber and the reflector in the SBR 12.

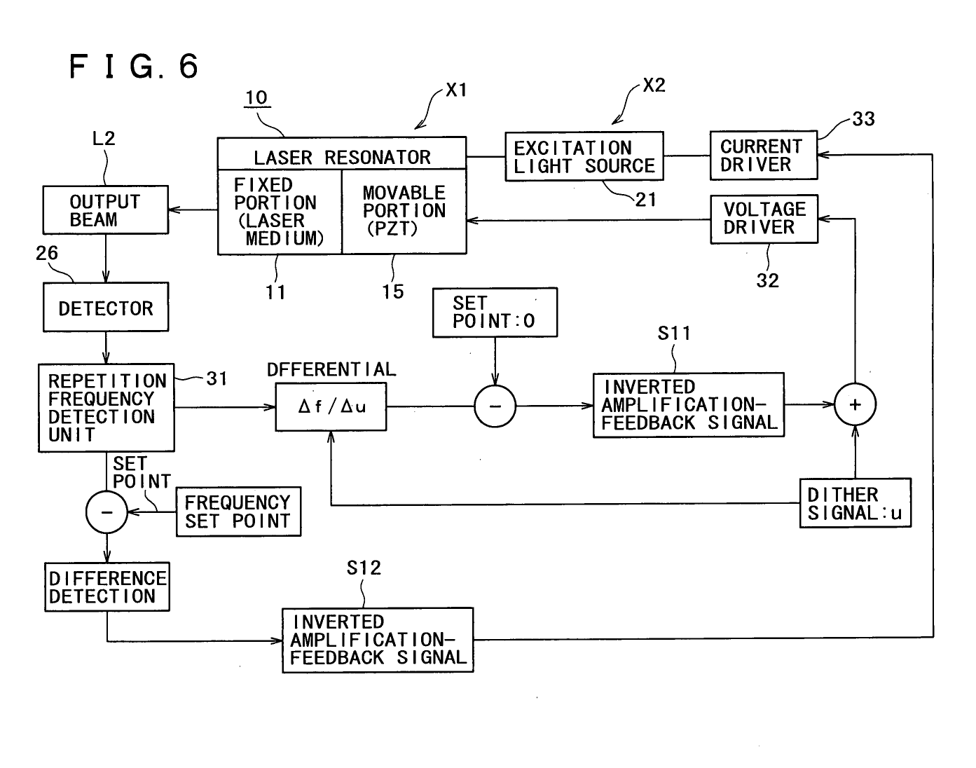

FIG. 6 shows the configuration in which a negative feedback circuit for varying the operating point by varying the current for the excitation light source 21 as above-mentioned is added to the functional block shown in FIG. 4, in order to brought the repetition frequency to a maximal value and further to equalize the maximal value to a desired repetition frequency.

In FIG. 6, the system is so configured as to correct variations of pulse repetition frequency (or pulse duty ratio) caused by two disturbances, namely, a first disturbance X1 exerted on the resonator and a second disturbance X2 exerted on the excitation light source (semiconductor laser LD) 21.

The portion relating to the first disturbance X1 is the same as the configuration shown in FIG. 4, and, therefore, description thereof is omitted here.

Incidentally, for simplifying the description, the second disturbance X2 is presumed to relate to the excitation light source (semiconductor laser LD) 21, but the following consideration covers also the case where the maximal value is varied by a variation in a characteristic of the resonator.

In a repetition frequency detection unit 31, the repetition frequency f is detected and is compared with a frequency set point. By the comparison, the difference is detected, thereby obtaining a second inverted amplification-feedback signal S12, which is different from the first inverted amplification-feedback signal S11 obtained from the primary differential signal Δf/Δu. The second inverted amplification-feedback signal S12 is supplied to a current driver 33 for passing a current to the excitation light source 21.

By this, it is possible to vary the operating point by changing the current for the excitation light source 21, whereby the repetition frequency f is corrected so as to accord to the set point.

Therefore, it is possible to lock the repetition frequency to a maximal value by use of the same portion as the system of FIG. 4, and thereafter to vary the maximal value and keep constant the maximal value by use of the portion added to the system of FIG. 4.

Incidentally, it is not impossible to achieve a similar correction by, for example, only varying the current supplied to the semiconductor laser LD in the excitation light source 21, without locking the repetition frequency to a maximal value. However, the operating point may be located in the multi-mode oscillation region shown in FIG. 3, and, therefore, the technique of changing only the current for the semiconductor laser LD without moving the operating point to the maximal value may lead to an operation in the multi-mode oscillation region. Accordingly, it is highly possible for the operation to become unstable, which is dangerous.

For this reason, the above-mentioned double servo system is preferred.

It is not impossible to configure the servo systems shown in FIGS. 4 and 6 by use of an analog circuit. However, it is considered to be suitable to adopt a digital servo system which permits free designing of conditional branches and parameter settings through programming, in view of the circumstances where a high-speed response is not demanded, a number of conditional branches are used, and so on.

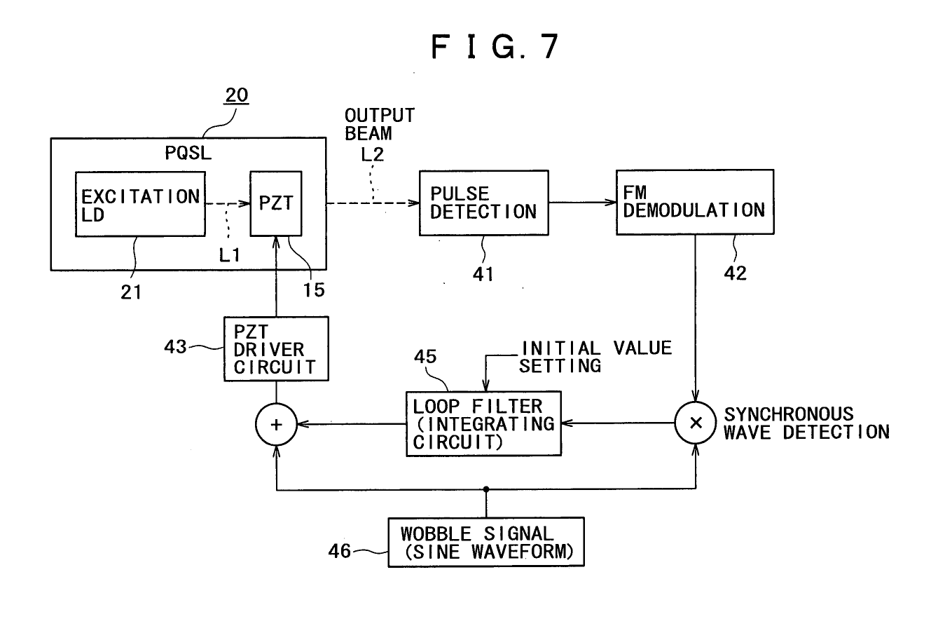

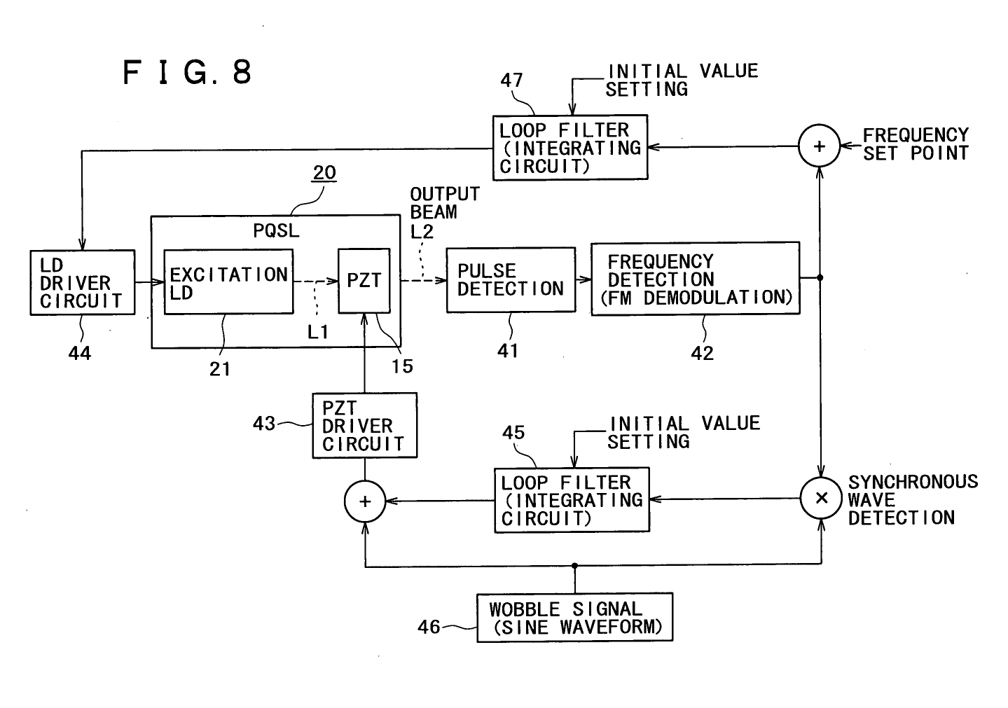

Other than the above, a servo system may be configured by use of a loop filter and a wobble signal, as indicated by forms of functional blocks shown respectively in FIGS. 7 and 8.

In the configuration shown in FIG. 7, pulse detection 41 from an output light L2 emitted from a laser beam generation system 20 is conducted by a detector or the like, the detected pulse is subjected to FM modulation 42, then the signal thus obtained is multiplied by a sine-wave wobble signal 46 to perform synchronous wave detection, and the result of the wave detection is passed through a loop filter (integrating circuit) 45. The wobble signal 46 is added to the signal from the loop filter (integrating circuit) 45, and the sum is supplied to a driver circuit 43 for driving resonator length regulation means 15 composed of PZT.

This makes it possible to control the resonator length regulation means 15 so that the average power of the output beam L2 becomes equal to a maximal value shown in FIG. 3. Thus, a servo system similar to that shown in FIG. 4 can be configured.

Besides, an initial value is set in the loop filter (integrating circuit) 45, and, therefore, it is possible to start the control from a stable condition.

In the configuration shown in FIG. 8, in addition to the configuration of FIG. 7, detection of repetition frequency is also conducted at the time of the FM modulation 42 of the detected pulse, the frequency thus detected is compared with a set point to obtain the difference therebetween, which is inputted to a second loop filter (integrating circuit) 47, and the signal from the second loop filter (integrating circuit) 47 is supplied to a driver circuit 44 for driving an excitation light source 21 composed of a semiconductor laser LD (namely, for passing a current to the semiconductor laser LD).

This makes it possible to control the current for the excitation light source 21 and thereby to achieve such a control that the repetition frequency of the output beam L2 becomes equal to the set point. Thus, a double servo system similar to that shown in FIG. 6 can be configured.

Besides, an initial value is set also in the second loop filter (integrating circuit) 47, and, therefore, it is possible to start the control from a stable condition.

Incidentally, a sine waveform as shown in FIGS. 7 and 8 is generally used for the wobble signal. When a square wave is used as the wobble signal, an arithmetic operation similar to that of a differentiating circuit shown in FIGS. 4 and 6 can be realized.

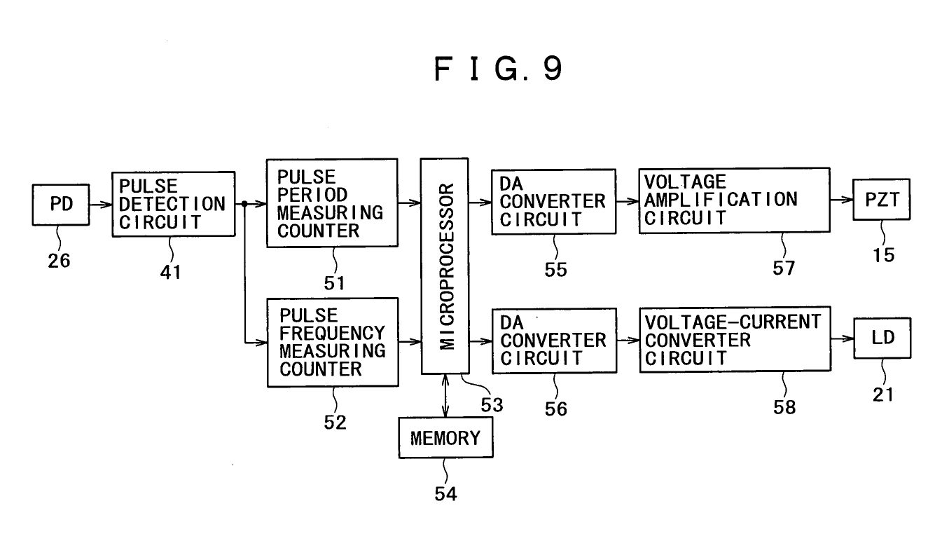

Besides, as shown in FIG. 9, use of a microprocessor and a memory also makes it possible to configure a circuit for controlling the laser beam generation system 20 comprising a Q switch laser.

In FIG. 9, from an output beam detected by a detector (PD) 26, a pulse is detected in a pulse detection circuit 41. Further, from the detected pulse, the period is measured by a pulse period measuring counter 51, while the frequency is measured by a pulse frequency measuring counter 52, and the period and the frequency thus measured are arithmetically processed by a microprocessor 53. A memory 54 stores the results of the arithmetic processing in the microprocessor 53 as well as preset values.

Then, the results upon the arithmetic processing in the microprocessor 53 are supplied through a first DA converter circuit 55 and a voltage amplification circuit 57 to resonator length regulation means 15 composed of PZT, whereby the resonator length is regulated.

Besides, the results upon the arithmetic processing in the microprocessor 53 are supplied through a second DA converter circuit 56 and a voltage-current converter circuit 58 to an excitation light source 21 composed of a semiconductor laser LD, whereby the output from the excitation light source 21 is regulated. This makes it possible to control the repetition frequency of the output beam from the laser beam generation system 20.

Therefore, according to the configuration shown in FIG. 9, also, a double servo system similar to those shown in FIGS. 6 and 8 can be constructed.

Incidentally, the functions indicated in the respective functional blocks in FIGS. 7, 8 and 9 can be realized also by use of software.

Configuration of a control circuit as shown in FIGS. 7 and 8 or as shown in FIG. 9 has the following merits, for example.

Each functional block is realized by use of addition, reduction, multiplication, and integration, the system can be realized even by use of analog arithmetic circuits.

Even where the system is realized by use of digital signal processings, the system can be realized by using simple hardware and software.

In FIGS. 7 and 8, integrating circuits are used as the loop filters 45, 47 to realize a linear feedback control circuit, whereby it is possible to easily realize a control which is stable and generates few steady-state errors.

In FIGS. 7 and 8, the loop filters 45, 47 have the function of setting an initial value, whereby the control system can start the control from a stable condition, and a stabler control can be achieved. Depending on the voltage applied to PZT 15 or the current passed to the excitation LD 21, there may be cases where the pulse period becomes unstable or the pulse light quantity becomes insufficient, making it impossible to achieve an accurate control. However, favorable control signals can be obtained, by initially setting a voltage or current which promises a stable pulse period or a sufficient light quantity.

According to the configuration of the laser beam generation system 20 in this embodiment as above-described, the laser oscillator 10 is provided with the resonator length regulation means 15, whereby variations in pulse repetition frequency and pulse duty ratio caused by disturbances such as minute variations of the resonator length and deterioration of the LD can be corrected, and be kept constant, by driving the resonator length regulation means 15 through application of a voltage or a current so as thereby to change the resonator length.

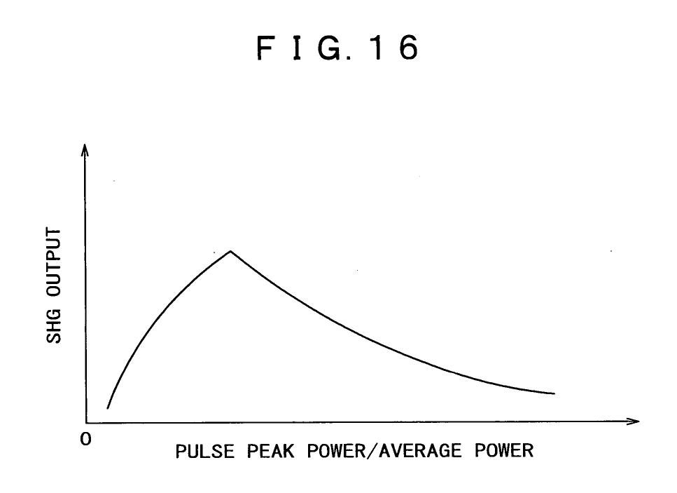

In addition, since the pulse duty ratio can be made constant, it is possible, for example where wavelength conversion is conducted in a latter stage, to maintain the output upon the wavelength conversion at an optimal point (corresponding to the peak of SHG output in FIG. 16).

Besides, by performing the correction, it is possible to maintain the fundamental specifications of pulse repetition frequency, output and the like for a long period of time, to contrive stabilization of the laser beam outputted from the laser beam generation system 20, and to enhance the reliability of the laser beam generation system 20.

Furthermore, as shown in FIGS. 4, 6, 7, 8, and 9, a servo system is configured for performing a control through detecting the output of the laser beam generation system 20 and the repetition frequency. This makes it possible to automatically keep constant the repetition frequency, average power, and pulse duty ratio of the output beam L2 from the laser beam generation system 20, to ensure a very stable operation for a long period of time, and to enhance the reliability of the laser beam generation system 20.

In addition, a control may be performed so as to ensure that the pulse duty ratio is located in a certain range when the repetition frequency and the pulse duty ratio are corrected and kept constant. This makes it possible, for example where wavelength conversion is conducted in a latter stage, to enhance the wavelength conversion efficiency, for example, to a maximum value, and to obtain a sufficient output upon the wavelength conversion.

Specifically, it is a common practice to ensure that an optimum value is reached when the ratio of the output pulse peak power to average power is in the range of from 100 to 2000. Generally, with the ratio in this range, an MOPA is configured as a master laser, and, further, a sufficient output is obtained upon wavelength conversion.

Particularly, where a servo system is configured for controlling also the current passed to the semiconductor laser LD of the excitation light source 21, the oscillation wavelength of the laser oscillator 10 can also be controlled, so that the oscillation wavelength can be controlled to the maximum value of laser output gain. With the oscillation wavelength thus controlled, it is possible, for example where wavelength conversion is conducted by use of a nonlinear optical crystal in a latter stage, to control the oscillation wavelength to a wavelength at which the efficiency of wavelength conversion by the nonlinear optical crystal takes a substantially maximum value.

While the excitation light source 21 for the laser oscillator 10 which is a Q switch laser is composed of the semiconductor laser LD in the above-described embodiment, the excitation light source in the present invention is not limited to a semiconductor laser. The present invention is applicable also to the cases where a solid state laser or other laser is used to constitute the excitation light source.

Furthermore, the laser beam generation system 20 according to the above-described embodiment may be used as a master laser, a light source or the like, whereby a variety of applied products can be configured.

Some examples of the applied products will be shown below.

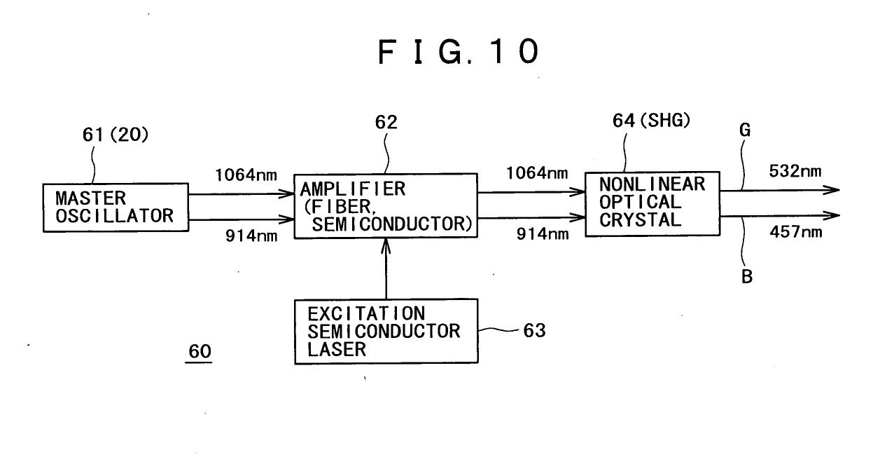

FIG. 10 shows, as an applied product, a laser beam generation system 60 in which the laser beam generation system 20 in the above-described embodiment is used as a master laser, and a second harmonic generation (SHG) is obtained from the output beam from the laser beam generation system 20.

The laser beam generation system 60 comprises a master oscillator 61, an amplifier 62 comprised of a fiber or a semiconductor, an excitation semiconductor laser 63, and a nonlinear optical crystal 64. The master oscillator 61 is configured by use of the laser beam generation system 20 according to the above-described embodiment, and emits a laser beam with a wavelength of 1064 nm and a laser beam with a wavelength of 914 nm. The beams emitted from the master oscillator 61 are amplified in the amplifier 62. The amplifier 62 is excited by the excitation semiconductor laser 63. The beams amplified by the amplifier 62 are incident on the nonlinear optical crystal 64. The nonlinear optical crystal 64 is an optical crystal which constitutes an SHG (Second Harmonic Generation) device. By being transmitted through the nonlinear optical crystal 64, the laser beam with the wavelength of 1064 nm and the laser beam with the wavelength of 914 nm undergo wavelength conversion, to give a green (G) beam (wavelength: 532 nm) and a blue (B) beam (wavelength: 457 nm), respectively.

Furthermore, since a red (R) beam can be obtained by an ordinary semiconductor laser, by combining the laser beam generation system 60 of FIG. 10 with the semiconductor laser, it is possible to obtain light sources of three colors, i.e., red (R), green (G), and blue (B), for a display.

In the laser beam generation system 60, the laser beam generation system 20 according to the above-described embodiment is used as the master laser, and variations in the pulse repetition frequency and pulse duty ratio of each of the laser beams oscillated from the master oscillator 61 are corrected, whereby the repetition frequency and the pulse duty ratio can be kept constant. Therefore, it is possible to keep constant the pulse peak powers and the oscillation wavelengths.

This makes it possible to stabilize the amplification characteristics in the amplifier 62, and to maintain the conditions (conditions of peak power and oscillation wavelength) under which the efficiency of wavelength conversion in the nonlinear optical crystal 64 is high, thereby keeping a high conversion efficiency.

Accordingly, the outputs of the beams (the beam in green (G) and the beam in blue (B)) emitted from the nonlinear optical crystal 64 can be stabilized.

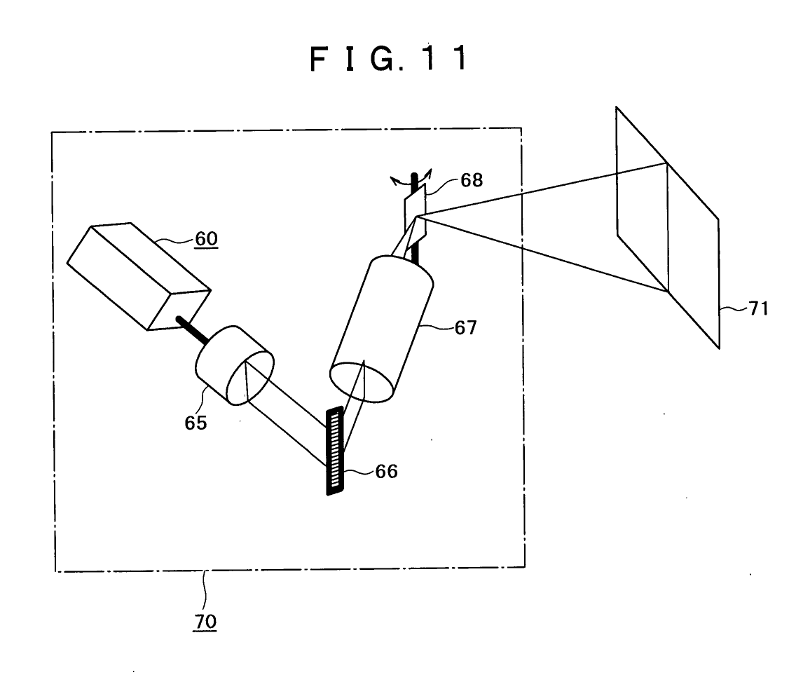

In addition, FIG. 11 illustrates, as an applied product, the case where the laser beam generation system 20 according to the above-described embodiment is used as a light source in a display.

The configuration of the display shown in FIG. 11 is an application to a display which is generally called a GLV (Grating Light Valve) display.

The display 70 comprises a laser light source composed of the same laser beam generation system 60 as shown in FIG. 10, an illumination lens 65, a light modulator 66, a projection lens 67, and a scanning mirror 68, and is for displaying an image on a screen 71 disposed outside the display 70.

The laser light source is for displaying one color of red (R), green (G), and blue (B), and two similar laser light sources (not shown) are further provided.

The light modulator 66 is composed of a GLV (Grating Light Valve).

The projection lens 67 incorporates a filter which transmits only diffracted light therethrough.

The scanning mirror 68, by being turned as indicated by arrows, performs scanning over the whole area of the screen 71. It performs scanning in the mode of progressive scan, 60 times per second, for example.

A display with 1920×1080 pixels, for example, is performed on the screen 71.

The display 70 comprises the laser light source composed of the laser beam generation system 60 in which the laser beam generation system 20 according to the above-described embodiment is used as a master laser, whereby the output of the beam (the beam in green (G) or the beam in blue (B)) emitted from the laser beam generation system 60 can be stabilized.

Therefore, it is possible to realize a display 70 capable of displaying a favorable image while stabilizing color tone and image quality.

Incidentally, particularly where the laser beam generation system 20 according to the above-described embodiment is used as a light source in such a display as this display 70, it is desirable to use a repetition frequency set point of not less than 1 MHz, preferably not less than 1.5 MHz, and a pulse width set point in the range of 0.1 to 2 nsec. It is to be noted, however, that such a setting may not necessarily be adopted in the cases where the laser beam generation system 20 is applied to other uses than a light source in a display.

If the repetition frequency is low, image quality may be deteriorated due to the generation of moiré or the like.

Besides, when the pulse width is below the above-mentioned range, pulse peak power becomes so high that it is necessary to take a special safety measure against the laser beam.

On the other hand, when the pulse width is above the range, images appear glittering.

The present invention is not limited to the above-described embodiments, and other various configurations can be adopted within the scope of the present invention.

1. A method of stabilizing a laser beam generated from a laser beam generation system comprising a solid state laser oscillator excited by an excitation beam, and a Q switch for pulsating laser oscillation by use of a saturable absorber, wherein
said laser beam generation system is so configured that the optical path length of a laser resonator can be varied,
a pulse of said generated laser beam is detected, and
the variation of said optical path length of said laser resonator is controlled based on a characteristic of said detected pulse.

2. A method of stabilizing a laser beam as set forth in claim 1, wherein the repetition frequency of said pulse of said laser beam detected or the cycle period of said pulse is detected from said pulse, as said characteristic.

3. A method of stabilizing a laser beam as set forth in claim 2, wherein said optical path length is varied, an error signal is produced based on the variation of said repetition frequency of said pulse, and the variation of said optical path length is controlled so that said error signal reaches a set point.

4. A method of stabilizing a laser beam as set forth in claim 3, wherein a dither signal is given to periodically vary said optical path length, in such a range that the width of said pulse can be deemed as substantially constant, and the variation of said optical path length is controlled based on said error signal obtained, so as thereby to maintain said repetition frequency in the vicinity of a maximal value.

5. A method of stabilizing a laser beam as set forth in claim 4, wherein said repetition frequency or said cycle period detected is compared with a set point to determine the difference therebetween, and said error signal is computed from said difference.

6. A method of stabilizing a laser beam as set forth in claim 5, wherein the quantity of light of said excitation beam is controlled based on said computed error signal while controlling said repetition frequency to within the vicinity of said maximal value.

7. A method of stabilizing a laser beam as set forth in claim 6, wherein a laser beam generated from a semiconductor laser is used as said excitation beam, and the current supplied to said semiconductor laser or the temperature of said semiconductor laser is controlled, to thereby control the quantity of light of said excitation beam.

8. A method of stabilizing a laser beam as set forth in claim 3, wherein a dither signal is given to periodically vary said optical path length, in such a range that the width of said pulse can be deemed as substantially constant, and the variation of said optical path length is controlled based on said error signal obtained, so as thereby to maintain said repetition frequency in the vicinity of a set point which is set at a value different from a maximal value.

9. A method of stabilizing a laser beam as set forth in claim 3, wherein negative feedback is conducted by use of said error signal, to automatically vary said optical path length, thereby controlling said repetition frequency.

10. A method of stabilizing a laser beam as set forth in claim 1, wherein the variation of said optical path length is controlled, to thereby control said pulse so that the ratio of pulse peak power to average power is brought into the vicinity of a set point.

11. A method of stabilizing a laser beam as set forth in claim 1, wherein said generated laser beam is subjected to wavelength conversion, and the output obtained upon said wavelength conversion is controlled to a set point.

12. A laser beam generation system comprising:
a solid state laser oscillator excited by an excitation beam, and
a saturable absorber Q switch for pulsating laser oscillation by use of a saturable absorber, wherein
said laser beam generation system further comprises:
resonator length regulation means for varying the optical length of a laser resonator, and
detection means for detecting a pulse laser beam outputted, and
said optical path length of said laser resonator is regulated by said resonator length regulation means based on a characteristic of the pulse detected by said detection means.

13. A laser beam generation system as set forth in claim 12, wherein the repetition frequency of said pulse of said laser beam detected or the cycle period of said pulse is detected from said pulse, as said characteristic.

14. A laser beam generation system as set forth in claim 13, further comprising a signal processing unit for producing an error signal based on said repetition frequency of said pulse detected, wherein the regulation of said optical path length of said laser resonator by said resonator length regulation means is conducted by use of said error signal produced by said signal processing unit.

15. A laser beam generation system as set forth in claim 14, wherein said optical path length is varied by said resonator length regulation means, to thereby vary said error signal produced by said signal processing unit, and the variation of said optical path length by said resonator length regulation means is controlled so that said error signal reaches a set point.

16. A laser beam generation system as set forth in claim 15, wherein a dither signal is given to said resonator length regulation means to periodically vary said optical length, in such a range that the width of said pulse can be deemed as substantially constant, said error signal is obtained through synchronous wave detection in said signal processing unit, and the variation of said optical path length is controlled, so as thereby to maintain said repetition frequency of said pulse in the vicinity of a maximal value.

17. A laser beam generation system as set forth in claim 14, wherein said repetition frequency or said cycle period detected is compared with a set point to determine the difference therebetween and said error signal is computed from said difference, in said signal processing unit.

18. A laser generation system as set forth in claim 14, wherein negative feedback is conducted by use of said error signal, and said optical path length is automatically varied by said resonator length regulation means.

19. A laser beam generation system as set forth in claim 12, wherein the variation of said optical length is regulated, to thereby control said pulse so that the ratio of pulse peak power to average power it brought into the vicinity of a set point.

20. A laser beam generation system as set forth in claim 12, wherein said excitation beam is a laser beam generated from an excitation light source comprised of a semiconductor laser.

21. A laser beam generation system as set forth in claim 14, comprising a semiconductor laser for generating said excitation beam, and a driver circuit for said semiconductor laser, wherein a current supplied to said driver circuit is controlled based on said error signal produced by said signal processing unit.

22. A laser beam generation system as set forth in claim 12, wherein the variation of said optical path length is regulated, to thereby control the oscillation wavelength of said solid state laser oscillator so that the gain of laser determined by respective spectral characteristics of a laser medium, said saturable absorber, and a reflector is maximized.

23. A laser beam generation system as set forth in claim 12, wherein the ratio of pulse peak power of said pulse to average power is in the range of 100 to 2000.

24. A laser beam generation system as set forth in claim 12, further comprising a light amplifier for amplifying an output beam from said Q switch, and wavelength conversion means for converting the wavelength of said beam amplified by said light amplifier.

25. A laser beam generation system as set forth in claim 24, wherein the variation of said optical path length is regulated, to thereby perform such a control that the wavelength conversion efficiency in said wavelength conversion means is substantially maximized.

26. A laser beam generation system as set forth in claim 24, wherein the oscillation wavelength of said solid state laser oscillator is controlled so that the wavelength conversion efficiency in said wavelength conversion means is substantially maximized.

27. A laser beam generation system as set forth in claim 26, comprising a semiconductor laser for generating said excitation beam, and a driver circuit for said semiconductor laser, wherein said oscillation wavelength is controlled by regulating a current supplied to said driver circuit.
